(19) United States
(12) Patent Application Publication
(10) Pub. No.: US 2009/0292094 A1
(43) Pub. Date: Nov. 26, 2009

(54) Fluoropolymer Composition

(75) Inventors: Roman B. Larichev, Wilmington, DE (US); Andrew Edward Feiring, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. duPont de Nemours and Company, Wilmington, DE (US)

(21) Appl. No.: 12/124,287

(22) Filed: May 21, 2008

(51) Int. Cl. C08F 214/18

(52) U.S. Cl. 526/254

(57) ABSTRACT

Amorphous copolymers comprising 50-80 mole percent of monomer units derived from tetrafluoroethylene and 20 to 50 mole percent of monomer units derived from 1,2,3,3,3-pentafluoropropylene are provided.

### FIELD OF THE INVENTION

The present invention is directed to fluoropolymer compositions comprising copolymers of 1,2,3,3,3-pentafluoropropylene and tetrafluoroethylene.

### BACKGROUND OF THE INVENTION

Sianesi et al., U.S. Pat. No. 3,350,373 discloses copolymers of 1,2,3,3,3-pentafluoropropylene and tetrafluoroethylene, a method for preparing them, and a process for melt forming shaped articles. Sianesi's polymers are crystalline polymers having 1,2,3,3,3-pentafluoropropylene comonomer concentrations of less than 20 mole percent.

Schmiegel et al., U.S. Pat. No. 6,664,339, discloses use of 0.1-15% of 1,2,3,3,3-pentafluoropropylene as a cure site comonomer in a fluoroelastomer composition.

Anolick et al., U.S. Pat. No. 5,478,905, discloses substantially amorphous copolymers of hexafluoropropylene and tetrafluoroethylene and a process for preparing them.

Hrivnak et al., U.S. Pat. No. 6,248,823, discloses solvents for so-called amorphous fluoropolymers. Amorphous fluoropolymers include copolymers of TFE with perfluoromethylvinylether, perfluoroethylvinylether, perfluoropropylene (HFP), perfluorodimethyldioxole, perfluoro-2-(2-fluorosulfonylethoxy)propyl vinyl ether, and others. Solvents disclosed include fluorinated alkanes, fluorinated alkenes, fluorinated sulfides, hexafluorobenzene and others. Amorphous fluoropolymers are characterized by having no melting transition with a heat of fusion greater than 1 J/g as determined by differential scanning calorimetry (DSC). The HFP copolymers are ca. 48 mole percent HFP.

Tuminello et al., U.S. Pat. No. 6,767,626, discloses a method for protection of stone by preparing coated stone surfaces using substantially amorphous copolymers of hexafluoropropylene and tetrafluoroethylene.

### SUMMARY OF THE INVENTION

The present invention provides, in one aspect, an amorphous copolymer comprising 50 to 80 mole percent of monomer units derived from tetrafluoroethylene and 20 to 50 mole percent of monomer units derived from 1,2,3,3,3-pentafluoropropylene.

### BRIEF DESCRIPTION OF FIGURES

FIGS. 1-3 show the differential scanning calorimetry scans for polymers prepared in the Examples.

### DETAILED DESCRIPTION

As used herein, the term “amorphous” refers to a polymer having no melting endotherm having a heat of fusion greater than 1 J/g as determined by differential scanning calorimetry (DSC). Amorphous copolymers of TFE with 1,2,3,3,3-pentafluoropropylene have not previously been reported.

As used herein, the term “soluble” when referring to a polymer means that the polymer combines in a liquid solvent to form a clear, homogeneous liquid solution or gel at room temperature. The manner by which the room temperature liquid solution or gel is prepared is not germane to the definition. Thus, a polymer observed to be insoluble at room temperature may be combined with the solvent and the combination heated with stirring to cause the polymer to enter solution at an elevated temperature, forming a clear homogeneous liquid. Just so long as the solution so produced when cooled to room temperature remains clear and homogeneous, either as a liquid solution or gel, the polymer is considered “soluble” in the solvent as the term is used herein. “Clear and homogeneous” are determined by simple visual inspection of the specimen in a clear glass vessel.

As used herein the term “copolymer” refers to a polymer comprising 20-50 mole percent of 1,2,3,3,3-pentafluoropropylene and 50-80 mole percent of TFE. The term further encompasses terpolymers or other multi-polymers wherein an additional one or more monomer units derived from olefinic monomers are included in the copolymer. However, the total of all the one or more additional monomer units is preferably not more than 10 mole percent.

When a copolymer is described herein as “comprising 20-50 mole percent of 1,2,3,3,3-pentafluoropropylene”, this means that the polymer comprises 20-50 mole percent of monomer units derived from 1,2,3,3,3-pentafluoropropylene upon polymerization with TFE. Similarly, when a polymer is described as “comprising 50-80 mole percent of TFE,” what is meant is that the polymer comprises 50-80 mole percent of monomer units derived from TFE upon polymerization with 1,2,3,3,3-pentafluoropropylene. Similar descriptions are used herein in the same manner.

The polymers disclosed herein are characterized by novel solubility characteristics that afford a high and unusual utility. Tetrafluoroethylene homopolymers are well-known to be virtually insoluble and intractable, partially because of high crystallinity and partially because of high molecular weight. Fluorinated copolymers of tetrafluoroethylene and other olefinic fluoromonomers such as hexafluoropropylene and perfluoropropylvinyl ether are insoluble at comonomer (i.e., non TFE) content below about 20 mole percent.

Hrivnak et al. disclose that at comonomer content of around 25 mole percent up to ca. 50 mole percent copolymers known in the art become substantially amorphous, and exhibit moderate to good solubility in a wide range of fluorinated solvents, as well as some other solvents such as hydrocarbons and supercritical CO₂. The copolymers disclosed herein exhibit a considerable decrease in crystallinity with increasing comonomer content. No melting endotherm having a heat of fusion greater than 2 J/g was observed in differential scanning calorimetry (DSC) of 1,2,3,3,3-pentafluoropropylene copolymers with TFE at comonomer content of 20-50 mole percent. However, the present inventors have found that, surprisingly, the solubility of the copolymers disclosed herein is limited to highly fluorinated aromatic hydrocarbon solvents. Solubility in other fluorinated solvents is not observed. Some polymer swelling is sometimes observed, but a liquid solution is not formed.

The observed novel solubility behavior of the copolymers disclosed herein provide varied utility for the copolymers. For example, a coating of a few micrometers up to perhaps 100 micrometers can be applied to a surface from solution in, e.g., hexafluorobenzene, in order to protect a surface. The surface so prepared can then be exposed to an environment in which non-aromatic fluorinated solvents are employed, for example in cleaning, without significant degradation of the protective coating.

As another example, multi-layer fluoropolymer coatings or laminates of fluoropolymers can be fabricated by applying a first layer of a coating to a substrate from a hexafluorobenzene solution of an embodiment of the polymer, followed by drying. A second layer of the coating of a second polymer, of different composition, can then be applied from a solution wherein the solvent is not a fluorinated aromatic hydrocarbon so that the first layer of the coating is undisturbed by the application of the second layer.

Accordingly, the present invention provides, in one embodiment, amorphous copolymers comprising 50-80 mole percent of monomer units derived from tetrafluoroethylene and 20 to 50 mole percent of monomer units derived from 1,2,3,3,3-pentafluoropropylene. In preferred embodiments a copolymer comprises 25 to 50 mole percent of monomer units derived from 1,2,3,3,3-pentafluoropropylene. In highly preferred embodiments a copolymer comprises 30 to 45 mole percent of monomer units derived from 1,2,3,3,3-pentafluoropropylene.

The polymers can be prepared according to methods known in the art. The composition of the copolymer can be varied by varying the composition of the monomeric mixture and the temperature at which the polymerization reaction is conducted. Generally, higher reaction temperatures favor incorporation of a higher proportion of 1,2,3,3,3-pentafluoropropylene units into the copolymer.

It is known that 1,2,3,3,3-pentafluoropropylene is less reactive in copolymerization than TFE under some conditions. A higher incorporation of 1,2,3,3,3-pentafluoropropylene into the copolymer, can be achieved when the polymerization mixture has a higher content of the 1,2,3,3,3-pentafluoropropylene than that which is desired in the final product. Thus, the monomer concentration of 1,2,3,3,3-pentafluoropropylene preferably ranges from about 50 mole percent to about 85 mole percent, and the concentration of TFE ranges from about 15 mole percent to about 50 mole percent.

The fluorinated copolymers can be prepared at temperatures ranging from about −30° C. to about 200° C., under pressures varying from atmospheric to above 300 atm., and in the presence of free-radical polymerization initiators. The preferred reaction temperature and pressure depend on the type of catalysis used. The polymerization can be carried out in an aqueous medium if desired, including polymerization in an aqueous suspension, aqueous emulsion, polymerization in bulk or in solution.

When polymerization is carried out in non-aqueous solution, inert solvents that do not contain C—H bonds are preferred. Suitable inert solvents include perhalogenated or perfluorinated compounds that are liquid under operating conditions, such as perfluorocyclobutane, perfluorodimethylcyclobutane, perfluoropropylpyrane, or tetrafluorodichloroethane. Suitable initiators include perhalogenated or perfluorinated peroxy compounds such as peroxides of trichloroacetic acid, heptafluorobutyric acid, trifluoroacetic acid, pentafluoropropionic acid, or perfluorocaprylic acid. In addition, peroxides of the w-hydroperfluoro acids having the general formula H(CF₂)ₙ—COOH wherein n ranges from 1 to 8 can be used.

In aqueous polymerization, suitable initiators include water-soluble organic peroxides, diperoxides or hydroperoxides, or inorganic peroxides. Suitable inorganic peroxides include ammonium or alkaline and alkaline earth metals persulphates, perphosphates, perborates, barium peroxide, sodium peroxide, or hydrogen peroxide. Suitable organic peroxides include benzoyl peroxide, p. chlorobenzoyl peroxide, 2,4-dichlorobenzoyl peroxide, acetyl peroxide, trichloroacetyl, peroxide, lauroyl peroxide, succinyl peroxide, di-t.-butyl peroxide, peroxides and hydroperoxides of methylethylketone and of cyclohexanone, t-butyl perbenzoate, t-butyl-hydroperoxide, or cumyl hydroperoxide. Aliphatic azo-compounds can also be employed, such as alpha, alpha′azobis(isobutyronitrile), alpha, alpha′-azobis(alpha-methyl-gamma-carboxybutyronitrile), alpha, alpha′-azobis (alpha, gamma-dimethyl-gamma-carboxy-valeronitrile), alpha, alpha′-azobis(alpha-propyl-gamma-carboxybutyronitrile).

Other ingredients that can be used in aqueous polymerization include emulsifying agents, activators, accelerators, modifiers, buffers, etc. Emulsifying agents include alkali, alkaline earth or ammonium salts of perhalogenated or ω-hydroperhalogenated fatty acids having 6 to 20 carbons atoms. Suitable activators include sodium bisulphite, metabisulphite and thiosulphate or, in general, any water-soluble reducing substance. The accelerators include salts of metals occurring in various valence states, such as soluble salts of iron, copper, silver, etc. The modifiers include mercaptans or the aliphatic halocarbons which may be employed to regulate the polymerization reaction. Suitable buffering agents include sodium or potassium mono- or bi-phosphates or mixtures thereof, sodium metaborate, or borax.

When the copolymerization reaction is carried out in water, it is preferred to operate at a temperature ranging from about 5° C. to 100° C. and more preferably at a temperature ranging from about 10° C. to 90° C. under a pressure ranging from atmospheric to 200 atm.

### EXAMPLES

### Example 1

5 g of a 20% solution of ammonium perfluorooctanoate was diluted to 100 mL with deionized water and combined with 0.20 g of ammonium persulfate (Sigma-Aldrich) (0.20 g) in a Hastelloy® C 400 cm³ autoclave. The autoclave was chilled to 5° C., evacuated, pressured with nitrogen to 400 psi and vented off. The pressuring and venting were repeated and a vacuum was then applied to the interior of the autoclave. The autoclave was then chilled to −30° C. 56 g of 1,2,3,3,3-pentafluoropropylene prepared in the manner described by Sianesi et al., op. cit. was condensed in followed by pressuring with 14 g of TFE) and sealing. The sealed autoclave was heated to 70° C. and held for 16 hours. During that time the pressure gradually decreased from 377 psi to 321 psi. The autoclave was cooled to room temperature, and the excess gases were vented off. A clear aqueous solution was removed from the reactor and frozen in dry ice for at least 4 hours. The frozen solution was then allowed to thaw and then filtered through #1 Whatman filter paper. The white residue was suspended in 500 ml of deionized water, stirred for 30 minutes, filtered again, and dried on the filter by pulling air through. The resulting polymeric residue was further dried in vacuum oven at 50° C. for 12 hours. 14.8 g of white spongy polymer was obtained after drying. The ¹⁹F NMR of the melted polymer (at 160° C.) showed four broad peaks which upon integration showed that the polymer contained 27 mole percent of 1,2,3,3,3-pentafluoropropylene.

180 mg of the polymer was dissolved in 3.3 g of hexafluorobenzene (Aldrich) by stirring at room temperature for 30 minutes to give a clear, homogeneous 5 wt.-% solution. The solution was cast on a regular glass plate using a 0.005 in. (127.5 micrometer) Doctor blade. After evaporation of the solvent a coating 1-2 micrometers thick remained on the glass plate.

Attempts to prepare similar solutions using other solvents resulted in mixtures that were neither clear nor homogeneous. Solvents employed were dichloromethane (OmniSolve), toluene (OmniSolv), acetone (EMD), Vertrel XF (2,3-dihydrodecafluoropentane—DuPont), Novec HFE 7500 (3-ethoxy-1,1,1,2,3,4,4,5,5,6,6,6-dodecafluoro-2-trifluoromethyl-hexane—Synquest).

0.5 g of polymer powder was placed between sheets of Kapton® Polyimide Film to form a sandwich. The sandwich was placed between the platens of a hydraulic press (Pasadena Hydraulics) and held at contact pressure for 5 minutes at 120° C. After the 5 minute pre-heat, the force on the press was increased to 15,000 lbs. and held for 3 minutes. Then the press was cooled to 60° C. and the pressure was released. A film approximately 75 micrometers in thickness was obtained. A second specimen was prepared under identical conditions except that the temperature was 135° C. and the resulting film was approximately 65 micrometers thick. In both cases, the films were clear, homogeneous, ductile and tough.

### Example 2

The procedures of Example 1 were repeated except that 56 g of 1,2,3,3,3-pentafluoropropylene and 9 g of TFE were used. During the polymerization the pressure decreased from 336 psi to 318 psi. 5.6 g of dry polymer were obtained. The ¹⁹F NMR of the melted polymer (at 115° C.) showed four broad peaks which upon integration showed that the polymer contained 36.5 mole percent of 1,2,3,3,3-pentafluoropropylene.

500 mg of the polymer was dissolved in 3.3 g of hexafluorobenzene by stirring at room temperature for 30 minutes to give a clear, homogeneous 13 wt-% solution.

Attempts to prepare similar solutions using other solvents were unsuccessful. The mixtures made were neither clear nor homogeneous. Solvents employed were dichloromethane (OmniSolve), toluene (OmniSolv), acetone (EMD), Vertrel XF (2,3-dihydrodecafluoropentane—DuPont), Novec HFE 7500 (3-ethoxy-1,1,1,2,3,4,4,5,5,6,6,6-dodecafluoro-2-trifluoromethyl-hexane—Synquest). The last Vertrel XF and Novec HFE made the polymer look like an oil, which stuck to the glass walls of the vessel, but did not form a solution.

### Example 3

The procedures of Example 1 were repeated except that 46 g of 1,2,3,3,3-pentafluoropropylene and 31 g of TFE were used and the autoclave was heated to 80° C. for ten hours. During the polymerization the pressure decreased from 530 psi to 367 psi. 29.3 g of dry polymer were obtained. The ¹⁹F NMR of the melted polymer (at 115° C.) showed four broad peaks which upon integration showed that the polymer contained 20 mole percent of 1,2,3,3,3-pentafluoropropylene.

The polymer did not dissolve in hexafluorobenzene at room temperature to any significant extent, but at 60° C. 200 mg dissolved fairly easily in 2 mL of hexafluorobenzene to give a clear solution. Upon cooling the solution down to room temperature it became a gel.

### Comparative Example A and Examples 4 and 5

In order to identify a melting endotherm and determine the heat of fusion, the following procedure was followed. A 7-10 mg of specimen was crimped in a standard sealed aluminum DSC pan. The specimen was placed in a TA Instruments model Q2000 DSC and heated rapidly (ca. 20 C.°/min) to a temperature in the range of 260-320° C. and held at temperature for 3 minutes followed by cooling to ca. 0° C. The specimen was then reheated to the maximum temperature of 260-320° C. at 10° C./min rate with the aid of a mechanical cooler for temperature control, and data was recorded. The location of the melting endotherm, where one existed, was determined visually, and the heat of fusion determined from the weight normalized integral of the melting endotherm.

### Comparative Example A

The procedures of Example 1 were repeated except that 49 g of 1,2,3,3,3-pentafluoropropylene and 26 g of TFE were used and the autoclave was heated to 80° C. for ten hours. During the polymerization the pressure decreased from 465 psi to 445 psi. 8.6 g of dry polymer were obtained. A DSC curve obtained between ca. 0° C. and 300° C. exhibited a broad shallow endotherm with a heat of fusion of ca. 6 J/g indicating a small amount of crystallinity. The ¹⁹F NMR of the melted polymer (at 115° C.) showed four broad peaks which upon integration showed that the polymer contained 17.5 mole percent of 1,2,3,3,3-pentafluoropropylene.

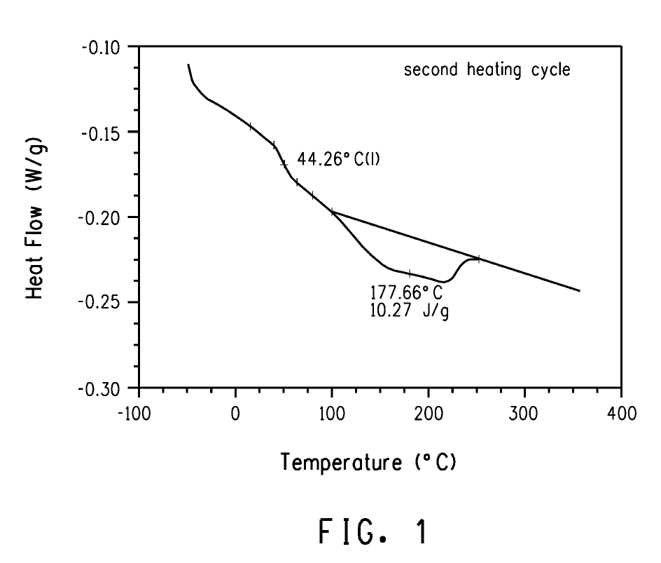

The polymer did not dissolve in hexafluorobenzene at room temperature. 100 mg of the polymer were suspended in 4 mL hexafluorobenzene (4 mL) and heated to 60° C. a clear solution was not obtained even on prolonged (4 hours) stirring. FIG. 1 shows the DSC results obtained according to the method described above. A well defined endotherm was identified corresponding to a melting transition at 177.66° C., and a heat of fusion of ca 10 J/g.

### Example 4

The materials and procedures of Example 1 were replicated except that the ratio of 1,2,3,3,3-pentafluoropropylene to TFE was slightly higher to give a polymer containing 30 mol-% of monomer units derived from 1,2,3,3,3-pentafluoropropylene.

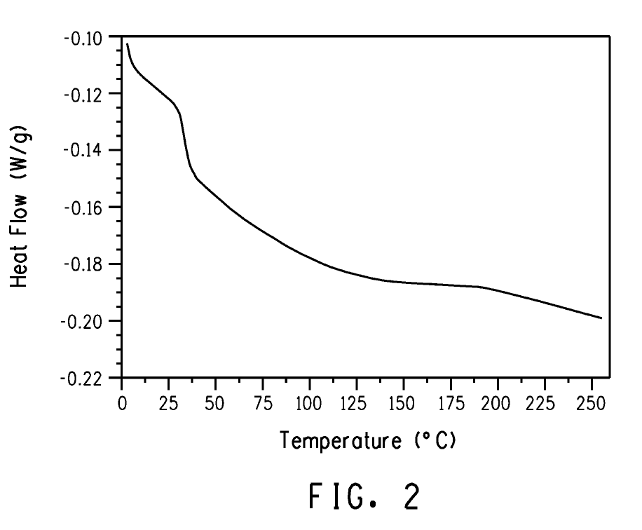

FIG. 2 shows the DSC results obtained. No melting endotherm could be discerned.

### Example 5

The materials and procedures of Example 1 were replicated except that the ratio of 1,2,3,3,3-pentafluoropropylene to TFE was slightly higher to give a polymer containing 40 mol-% of monomer units derived from 1,2,3,3,3-pentafluoropropylene.

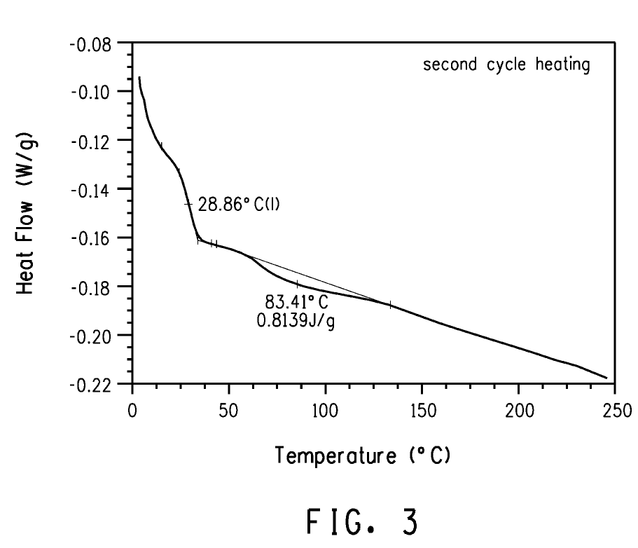

FIG. 3 shows the DSC results obtained. A very small melting endotherm associated with a crystalline melting point of 83° C. might be an artifact. The associated heat of fusion was 0.7 J/g.

What is claimed is:

1. An amorphous copolymer comprising 50-80 mole percent of monomer units derived from tetrafluoroethylene and 20 to 50 mole percent of monomer units derived from 1,2,3,3,3-pentafluoropropylene.

2. The copolymer of claim 1 comprising 25 to 50 mole percent of monomer units derived from 1,2,3,3,3-pentafluoropropylene.

3. The copolymer of claim 2 comprising 25 to 45 mole percent of monomer units derived from 1,2,3,3,3-pentafluoropropylene.

4. The copolymer of claim 1 further comprising up to 10 mole percent of one or more additional monomer units derived from olefinic monomers.
